(19) United States
(12) Patent Application Publication
(10) Pub. No.: US 2016/0253911 A1
(43) Pub. Date: Sep. 1, 2016

(54) PLAYGROUND SYSTEM

(71) Applicant: KOMPAN A/S, Odense SO (DK)

(72) Inventors: Jeanette Fich Jespersen, Odense SV (DK); Soren Skott, Odense NO (DK); Peter Christian Lovfold Gronfeldt, Odense (DK); Henrik Lindberg, Odense SV (DK); Stig Mose Henriksen, Svendborg (DK); Torben Hundevad, Odense NV (DK)

(21) Appl. No.: 15/033,461

(22) PCT Filed: Oct. 29, 2014
(86) PCT No.: PCT/EP2014/073235

§ 371 Date: Apr. 29, 2016

Related U.S. Application Data
(63) Continuation-in-part of application No. 14/148,445, filed on Jan. 6, 2014, now abandoned.

(30) Foreign Application Priority Data
Oct. 31, 2013 (EP) 13191166.1

(51) Int. Cl. G09B 5/06; G06F 3/0481; G06F 3/0484; A63G 31/00; G06F 3/0488

(52) U.S. Cl. CPC G09B 5/065; A63G 31/00; G06F 3/04883; G06F 3/0484; G06F 3/0481

(57) ABSTRACT

A playground system having a playground installation relating to one of a number of educational and/or entertainment themes, a handheld computer device, and a database of a number of digital applications with digital educational and/or entertainment content elements relating to one of the themes. The playground installation has an ID element identifiable by the computer device for identification of the theme of the playground installation. The computer device has an identifier for identification of the element and is configured for accessing the database and digital application relating to the theme of the playground installation such that a user can use the digital educational and/or entertainment content elements relating to the same theme as the theme of the playground installation. A method for providing an educational and/or entertainment context between a playground installation relating to one of a number of educational and/or entertainment themes and a handheld computer device is also provided. A method of learning including a playground installation with a three-dimensional physical object relating to an educational theme is provided along with a handheld computer device having a digital educational content element relating to the same educational theme. The digital educational content element has a digital representation of the physical object of the playground installation. A user is allowed access to the physical object and the digital educational content element, thereby promoting the user to relate the physical object to its corresponding digital representation to increase the user's understanding of the educational theme.

### FIELD OF THE INVENTION

The present invention relates to a playground system comprising a playground installation, a handheld computer device, and a database of a number of digital applications. The invention furthermore relates to a method for providing an educational and/or entertainment context between a playground installation relating to one of a number of educational and/or entertainment themes and a handheld computer device.

### BACKGROUND

Very often playing activities and learning or educational and/or entertainment activities are performed separately from each other, e.g. playing activities taking place at a playground and learning or educational and/or entertainment activities taking place in a classroom. However, several studies of children and of different educational and/or entertainment systems indicate strongly that the learning and training is improved in general by the mixture and combination of physical objects and physical activities with the traditional more literary learning processes. To this end different educational and/or entertainment toys have been provided which allow people, in particular children, to learn while playing.

U.S. Pat. No. 4,378,216 discloses an educational apparatus employing playground equipment or the like. The apparatus utilizes a plurality of objects of such form and size as to involve human learners, especially children, in physical activity while learning given letters of the alphabet. Each object is in a form and shape already familiar to the children by way of both appearance and name and the forms and names are selected on the basis that each object descriptive word or name contains a letter to be learned. However, the apparatus of U.S. Pat. No. 4,378,216 is static in the sense that once a descriptive word or name has been selected, it cannot be changed. Therefore it is not possible to change or adjust the apparatus in such a manner that it can be selectively directed towards various age groups and/or a different educational focus. Also, the objects placed on the playground of U.S. Pat. No. 4,378,216 are separate and individual without any interrelation.

### DESCRIPTION OF THE INVENTION

It is an object of embodiments of the invention to provide an educational and/or entertainment playground system, which combines outdoor physical activities on a playground with digital educational and/or entertainment activities for enhanced learning and playing experience for the user. Correspondingly it is an object to provide a method for providing an enhanced educational and/or entertainment context between a playground installation and a handheld computer device.

It is a further object of embodiments of the invention to provide a playground system providing the user with increased possibilities to play interactively and with improved interaction possibilities between the physical and digital playing elements.

It is a yet further object of embodiments of the invention to provide a playground system which can easily be configured to match a specific age group and/or a specific educational and/or entertainment focus.

In accordance with the invention this is obtained by a method for providing an educational and/or entertainment context between a playground installation relating to one of a number of educational and/or entertainment themes and a handheld computer device, the method comprising:

providing on the playground installation an ID element identifiable by the computer device and for identification of the educational and/or entertainment theme of the playground installation;

providing a database of a number of digital applications, each application comprising digital educational and/or entertainment content elements relating to one of the educational and/or entertainment themes;

using an identifier in the computer device to recognize the identifiable ID element and identify the educational and/or entertainment theme of the playground installation;

using the computer device to access the database and access the digital application relating to the educational and/or entertainment theme of the playground installation, thereby providing a user of the playground installation access to the digital educational and/or entertainment content elements relating to the same educational and/or entertainment theme as the educational and/or entertainment theme of the playground installation.

Also, the invention relates to a playground system comprising a playground installation relating to one of a number of educational and/or entertainment themes, a handheld computer device, and a database of a number of digital applications, each application comprising digital educational and/or entertainment content elements relating to one of the educational and/or entertainment themes. The playground installation comprises an ID element identifiable by the computer device for identification of the educational and/or entertainment theme of the playground installation, and the computer device comprises an identifier and is configured for accessing the database and accessing the digital application relating to the educational and/or entertainment theme of the playground installation upon identification of the ID element by means of the identifier, such that a user of the playground installation can use the digital educational and/or entertainment content elements relating to the same educational and/or entertainment theme as the educational and/or entertainment theme of the playground installation.

In the present context the term ‘playground installation’ should be interpreted to mean a construction or structure arranged in a playground, fitness area, or recreational site, e.g. a climbing frame, a jungle gym, a chute, a swing, a sports court, a seesaw, etc. Thus, the playground installation can be a relatively large structure which is permanently arranged, e.g. at an outdoor site or an indoor facility where children or grown-ups play or are physically active.

The handheld computer device may for example be a phone, smartphone, tablet, hand held console, laptop computer, palmtop, or a personal digital assistant (PDA).

The database may be stored locally in the handheld computer device or may be accessible via a digital network or a combination hereof. As an example the accessing of the database by the computer device may comprise contacting a database such as for example an app store, searching and requesting the database for permission to access the digital application relating to the educational and/or entertainment theme of the playground installation. The accessing of the digital application may be performed online via a network connection or may include downloading the application to a local memory in the computer device.

The system comprises a database of a number of digital applications, each application comprising digital educational and/or entertainment content elements relating to an educational and/or entertainment theme. In the present context the term ‘digital educational and/or entertainment content elements’ should be interpreted to mean a digital item, such as for example visual, narrative or interactive items including games, storytelling, video clips or pictures, exercises, puzzles, audio or visual information and the like. The content elements are educational and/or entertainment in having an direct or indirect educational and/or entertainment purpose or aim such as for example focusing on but not limited to improving the memory, motoric, dexterity, coordination, cognitive, linguistic, mathematical, musical, physical, learning, reasoning, problem solving, decision making, strategic planning or thinking, or social capabilities of the user, or combinations hereof. An educational and/or entertainment focus could also be a specific topic within one of the foci mentioned above, such as gravity, spelling, or specific arithmetic operations.

Each digital application may optionally be directed towards a specific age group and/or a specific educational and/or entertainment focus. Accordingly, if a given application is directed towards an age group, the educational and/or entertainment content elements of the given application are all of a kind which contributes to education or learning of people, in particular children, of that specific age group. For instance, the educational and/or entertainment content elements may define activities which are suitable for the specific age group, and which match the skills and support the development of children within the specific age group.

Examples of educational and/or entertainment themes could be a story such as one or more specific fairy tales (for example the ugly duckling, the little mermaid, or the tinderbox), an environment (such as for example a grocery store, a farm, or a fire station), or contextual (such as for example animals, cartoon characters, movie stars, or plants).

Thus, the method and the playground system according to the invention advantageously provide the user at a playground with an easy, fast, and simple access to one or more digital applications related and relevant to the playground installation.

By means of the identifiable ID element of the playground installation is obtained a link and a connection between the physical playground installation and the digital application both relating to the same educational and/or entertainment theme, and allowing the two to be used and explored at the same time or in parallel, thereby increasing the educational and/or entertainment and recreational value of both the playground installation and the digital application.

Further, the method and the playground system according to the invention are advantageous in providing a more complete educational and/or entertainment system in comprising both physical and virtual component related to the same educational and/or entertainment theme. This enables a system and a method of learning and developing skills where the physical components support and interacts with the digital educational and/or entertainment content elements, and the digital educational and/or entertainment content elements provide new functions or possibilities to the physical playground installation. In this way a new layer of use is added to the playground as well while on the same time the learning and educational and/or entertainment perspective of the digital content elements are enhanced. This may especially be the case for a large group of persons, where learning is seen to be greatly improved by the combination of physical objects and physical activities with the traditional more literary learning processes.

Here, the physical structures of the playground installation aid the user in the understanding and perception of for example written or spoken word as displayed by the computer device, and thereby increases the linguistic capabilities of the user.

Further, the playground system of the invention increases the fun and joy for the user of both the physical playground installation and of the digital applications as they interact and provides the user with a possibility to use both at same time or switch between the two without leaving the playing environment or the universe of the playing theme.

Also, the educational and/or entertainment theme of the playground allows the users to play and act the story, fairytale, or game of the digital application on the computer device, thereby increasing the understanding of the story or game and its underlying message or meaning, problem area, or morale, hereby increasing the perception by the user. Alternatively or additionally, this can be used with the objective of improving or expanding the social skills of a group of users by encouraging social relationships and interaction between the users.

On the same time, the digital application accessible on the computer device may be used to increase the users perception of the playground, inspiring the user to new or alternative ways of playing or move about in the playground installation, and act to increase or change the physical activity of the users. This may be performed with different objectives such as for example with the aim of increasing the cardio burning of the user, increasing the speed, increasing the motoric capabilities of the user, or combinations hereof.

Further, the system according to the invention is flexible in the sense that it can easily be configured to meet educational and/or entertainment requirements of a specific age group and/or related to a specific educational and/or entertainment focus, simply by selecting an appropriate digital application for the identified theme of the playground installation or by selecting an appropriate digital educational and/or entertainment content element within the relevant application.

In an embodiment the playground installation comprises a number of three-dimensional physical objects all relating to the same educational theme, and the educational content element comprises a digital representation of a story comprising references to all the objects. Further, the physical objects are placed on the playground installation such as to encourage the user to play the story.

Hereby is advantageously obtained that the user is both presented digitally with a story with all the advantages and possibilities a digital representation of a story provides such as a representation tailored to a specific age, learning stage, or need, or tailored to a specific group of users with a special educational or social focus, or a representation exploiting the different possibilities of the media such as combinations of visual, sound and 3D effects etc.

By the combination of the digital representation of a story and the playground comprising a number of three-dimensional physical objects the user or group of users can play and enact the story or parts hereof for example by following fully or to some extent the storyline of the story or reenacting the story with the digital representation as a basis or point of departure. This allows the user to obtain a deeper understanding of not only the different separate elements of the story being told but also of the meaning of the story, its message or morale and of the different persons actions, motivation or reasons for acting how they do in the story and of the social, physical and psychological interactions between the roles in the story. Advantageously the story is a fairytale, as the different persons (either humans, animals or supernatural or magical creatures such as mermaids, witches and the like) here undergo a development typical involving a series of choices or actions to be taken with corresponding consequences explaining who the person is, which elements and built-in fights between good and evil (or just simply between smart and stupid) can help the user through the enactment of the story to understand the story better and thereby its underlying conflicts, motifs and morale.

In an embodiment the physical objects are placed on the playground installation relative to each other according to their relationship in the story. Hereby the user is able to better enact the story and to understand the story through actual physical action corresponding to the actions or development happening in the story. For example, in the case where the story is the tinderbox by H. C. Andersen, the physical objects may comprise a witch which has to be dodged to reach a tree-like structure which can be entered from the top and climbed down.

In an embodiment the digital representation comprises a textual, sound or image representation of the physical object.

In an embodiment the digital educational content element comprises displaying a story in text and/or images on a screen of the computer device and the digital representation comprises a textual or image representation of the physical object playing a part in the story.

In a further embodiment the computer comprises sound emitting means, and the digital educational content element comprises playing a story via the sound emitting means, and the digital representation comprises a sound representation of the physical object playing a part in the story.

As also mentioned above this allows for an enhanced representation of the story by exploiting the different technical possibilities of the computer device.

In an embodiment the physical object of the playground comprises an ID element identifiable by the computer device for identification of the educational theme of the playground installation, and the computer device comprises an identifier and is configured for accessing a database, the database comprising a number of digital applications, each application comprising digital educational content elements relating to an educational theme. The computer device is further configured for accessing the digital application relating to the educational theme of the playground installation upon identification of the ID element by means of the identifier. In this way a user of the playground installation can use the digital educational content elements relating to the same educational theme as the educational theme of the playground installation.

The database may be stored locally in the handheld computer device or may be accessible via a digital network or a combination hereof. As an example the accessing of the database by the computer device may comprise contacting a database such as for example an app store, searching and requesting the database for permission to access the digital application relating to the educational theme of the playground installation. The accessing of the digital application may be performed online via a network connection or may include downloading the application to a local memory in the computer device.

The system comprises a database of a number of digital applications, each application comprising digital educational content elements relating to an educational theme.

Thus, the playground system according to the invention advantageously provides the user at a playground with an easy, fast, and simple access to one or more digital applications related and relevant to the playground installation.

By means of the identifiable ID element of the playground installation is obtained a link and a connection between the physical playground installation and the digital application both relating to the same educational theme, and allowing the two to be used and explored at the same time or in parallel, thereby increasing the educational and recreational value of both the playground installation and the digital application.

According to an embodiment of the invention, the handheld computer device comprises a camera or a video apparatus forming part of the identifier. Hereby the identifier may be formed by means of a component which is a standard component in many modern computer devices and which is simple and relatively fast to operate. Also, this makes it very easy for the user to obtain the information, since he or she merely has to arrange the handheld device, e.g. a cell phone, near the identifiable element, or optionally use a built-in zoom function to be able to stand further away.

In an embodiment of the invention, the ID element identifiable by the computer device comprises a marker belonging to the group of bar codes, QR codes, ID markers, electronic passive or active tags such as RFID tags, frame markers, picture markers, pattern marker, markerless 3D markers, GPS, and LLA (latitude/longitude/altitude), markers.

Additionally or alternatively, the ID element is identifiable by the computer device by means of shape, pattern, audio, or text recognition.

Hereby is provided a rather broad variety of possible markers or identifiable ID elements to be applied to link the playground installation to the relevant digital applications. Therefore the type of identifiable ID element may be used as most advantageous under the given surroundings or conditions of the playground installation and which may advantageously be fitted onto or used on very different components of the playground installation such as for example very visibly on a sign post, relatively discretely as a part of the decorating or shape of the playground installation, on a moving or stationary component of the playground installation as desired. By way of example, the identifiable ID element may be a QR or bar code displayed on the playground installation optionally together with information of its use. Alternatively, the identifiable ID element may form part of an object or component of the playground installation which is easily recognizable by the user and intuitively central to the playground installation and its theme, such as for example a figure of an ugly duckling in a playground structure with the fairy tale of The Ugly Duckling as a central theme.

In an embodiment the ID element comprises electronic ID data and is transferred to the computer device for identification by the computer device by means of communication means such as radio communication, IR (Infra-red) communication, a wire connection, or a docking station. In this way the computer device may be plugged into the playground installation via a wire or a docking station or the like, or may receive the ID data via radio communication such as Bluetooth or other protocols.

Additionally the identifiable ID element of the playground installation may be used for further purposes in the corresponding digital application. The identifiable ID element may in one embodiment be used in an augmented reality application on the computer device for the creation of a live, direct or indirect, view of the physical, real-world environment with one or more augmented elements. By means of Augmented Reality technology (which may include adding computer vision and object recognition) the information about the surrounding real world of the user hereby can be made interactive and can be digitally manipulated. Also, artificial or virtual information about the physical environment and the different physical objects can then be overlaid on the real world.

This may in one embodiment be used to display or take pictures or videos of the playground installation where one or more of the physical components of the playground installation are depicted as virtual objects. For example to take a picture of a person in the playground installation mentioned above with a theme of the fairy tale of The Ugly Duckling, where the identifiable ID element of the ugly duckling is then displayed as a cartooned cute little duckling or as a big swan. In another embodiment, the identifiable object of a playground installation may be the seat of a swing, which in the augmented reality displayed on the computer device turns into a dragon with a child riding it. The application may be interactive allowing the user of the computer device to ‘shoot down’ the dragon by tapping it.

In an embodiment of the invention, the handheld computer device comprises a video and at least one motion sensor and a processor configured for determining the position and orientation of the computer device relative to the playground installation based on data from the motion sensor and the video. Hereby the position and orientation of computer device relative to the playground installation can be determined, and may advantageously be used in augmented reality applications on the computer device as a means of interacting between the physical playground and the digital educational and/or entertainment applications of the computer device. The position and orientation data may be determined continuously or at time intervals.

In an embodiment of the invention, the handheld computer device further comprises a database of virtual objects relating to the educational and/or entertainment theme of the playground installation and a touch sensitive screen for displaying an image frame including the playground installation as detected by the camera or the video, and further comprising a processor configured for rendering a virtual object relating to the educational and/or entertainment theme of the playground installation on the screen within the image frame of the playground installation corresponding to the physical position of the identifiable ID element in the playground installation.

Hereby is displayed an image frame of the playground installation on the computer device with the identifiable ID element displayed in an augmented reality replaced by the virtual object. This feature further add to the interaction and combination of the physical playground installation and the digital application as applied on the computer device also because the virtual object representing the identifiable ID element relates to the same educational and/or entertainment theme as the playground installation and the digital content elements. Hereby the educational and/or entertainment and recreational value of the playground installation as well as of the digital application is further increased creating new possibilities of using and playing with both parts. Examples of augmented reality applications are mentioned previously.

The database of virtual objects may be the same or a different database as the database of digital educational and/or entertainment applications, and may be placed locally on the computer device or accessed via a digital network.

In an embodiment of the invention, the playground installation further comprises a number of light and/or sound emitting devices controllable by the computer device. The devices may comprise lights, horns, diodes, speakers or the like. In a further embodiment, the playground installation further comprises a number of touch and/or sound sensitive devices configured to be activated by a user of the playground installation. Hereby the digital application of the computer device re made further interactive with the physical installation such that the user playing on the physical playground installation may affect the course or later actions of the digital content element being run on the computer device, and such that the computer device may change the appearance and thereby function of the playground installation by means of the light and/or sound emitting devices. In this way an educational and/or entertainment content element may be directed at increasing or controlling the physical activity of a person which for example has to follow a series of lights or sounds or has to activate a given series of the touch or sound sensitive devices. In an embodiment, an educational and/or entertainment content element may be directed at increasing the linguistic control or understanding of one or more persons, which for example has to spell a word to gain points in a game by means of the devices which are then each given one or more letters. Such devices either controllable by the user or by the computer may thus be used in a broad variety of digital applications with different educational and/or entertainment or training aim and purpose.

In a further embodiment of the invention, the playground installation further comprises an audio device for playing a story relating to the educational and/or entertainment theme of the playground installation. Hereby the educational and/or entertainment theme may be presented to one or more user at a time by simple yet effective means.

In an embodiment the identifiable ID element of the playground installation is recognized by means shape, pattern, audio, or text recognition.

According to a further embodiment, the method further comprises obtaining data from a motion sensor and from a video of the computer device, and determining the position and orientation of the computer device relative to the playground installation based on said data.

In a further embodiment the method also comprises displaying an image frame including the playground installation as detected by a camera or a video of the computer device, identifying an identifiable ID element of the playground installation within the image frame, and rendering a virtual object relating to the educational and/or entertainment theme of the playground installation on the image frame such as to correspond to the physical position of the identifiable ID element in the playground installation.

The method may according to a further embodiment comprise tracking the identifiable ID element over time.

In an embodiment the device further comprises a multi-sensor integrator module configured to interpret the tracking of the identifiable ID element over time. The interpretation comprises using target state information of motion of the device in relation to the playground ID element, including preferably speed, position, and acceleration, and processing this information to place an animated layer based upon this information.

In an embodiment the method comprises modifying the one or more retrieved virtual objects such as to correspond to the position and orientation of the computer device relative to the playground installation, and placing an animated layer comprising the modified virtual object on the image frame based upon the tracking of the identifiable ID element over time and on the motion of the device in relation to the playground installation.

In this way the animated layer and elements therein can be placed in accordance with the displayed part of the playground so that for example relative sizes, orientation, lighting etc. match.

In an embodiment the virtual object is retrieved from a database comprising a number of virtual objects each relating to one or more of the educational and/or entertainment themes of different playground installations. The virtual object may be linked to the different themes such that an appropriate virtual object is retrieved from the database based on the identification of the ID element of the playground and/or based on an identification of the playground using a camera or video of the computer device. In this way the method ensures that a virtual object relevant to the playground theme or even to a specific portion of the playground is retrieved and used in the digital application on the device. For example, taking a picture of a specific part of a playground relating to the fairytale of the ugly duckling may cause the little duckling to be rendered on the device and play a part in the story on the device, whereas a picture of another portion of the playground may retrieve the full-grown swan to be displayed.

In an embodiment, the method further comprises detecting touch based input from the user and associating an action to the virtual object when touched by the user.

The advantages of these embodiments of the invention are as described above in relation to the playground system.

### BRIEF DESCRIPTION OF THE DRAWINGS

In the following different embodiments of the invention will be described with reference to the drawings, wherein:

FIG. 1 shows a playground installation of a playground system according to an embodiment of the invention and with a QR code for identification of the educational and/or entertainment theme of the playground installation,

FIGS. 2-3 illustrate the interaction between a playground installation, a computer device and a database according to an embodiment of the playground system,

FIG. 4 illustrates embodiments of interaction between a playground installation and a digital educational and/or entertainment application comprising different digital educational and/or entertainment content elements,

FIG. 5 shows two other embodiments of playground installations,

FIGS. 6A-6D are a flow chart and sketches illustrating the application of object recognition used to create an augmented reality, and the interaction with the applications augmented reality animation (the virtual layer) by ways of triggering and executing the animation, and

FIGS. 7-11 show different embodiments of playground installations with different identifiable elements.

### DETAILED DESCRIPTION OF THE DRAWINGS

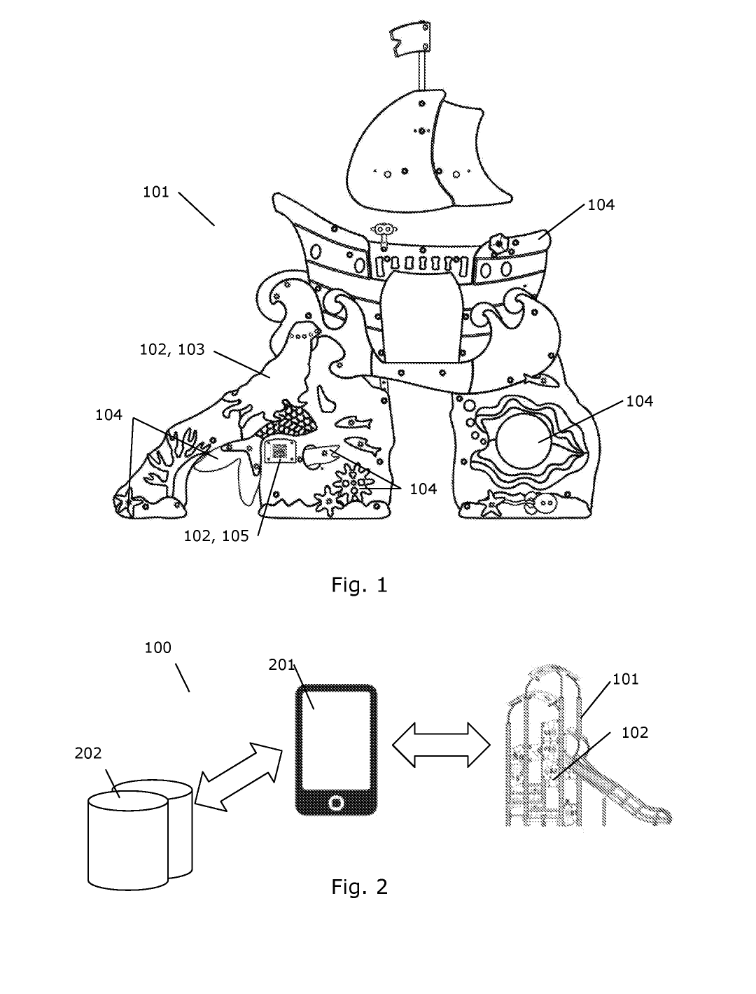

FIG. 1 shows an embodiment of a playground installation 101 of a playground system 100 and relating to in this case to the theme of the fairy tale of ‘The Little Mermaid’ 103. The playground installation comprises here a number of play components 104 with reference to the theme and which may act to stimulate the playing on the playground, such as different figures (the little mermaid, a ship of the humans, and different fish), tactile elements (a soft rubber tale of the mermaid, a textured starfish), movable elements and the pearl with the mirror effect. The playground installation 101 further comprises an ID element 102 identifiable by a computer device for identification of the educational and/or entertainment theme of the playground installation. In this playground installation the identifiable ID element is a QR code 105 which can be scanned by an identifier of a handheld computer device. Another identifiable ID element 102 is the little mermaid 103, which can be recognized by a computer device by shape recognition.

Two other different embodiments of playground installations 101 are shown in FIG. 5. Here the educational and/or entertainment theme is the fairy tale of The Tinderbox and The Ugly Duckling by H. C. Andersen, and identifiable elements 102 of the playground installation comprises a QR-code, the soldier figure, and the swan.

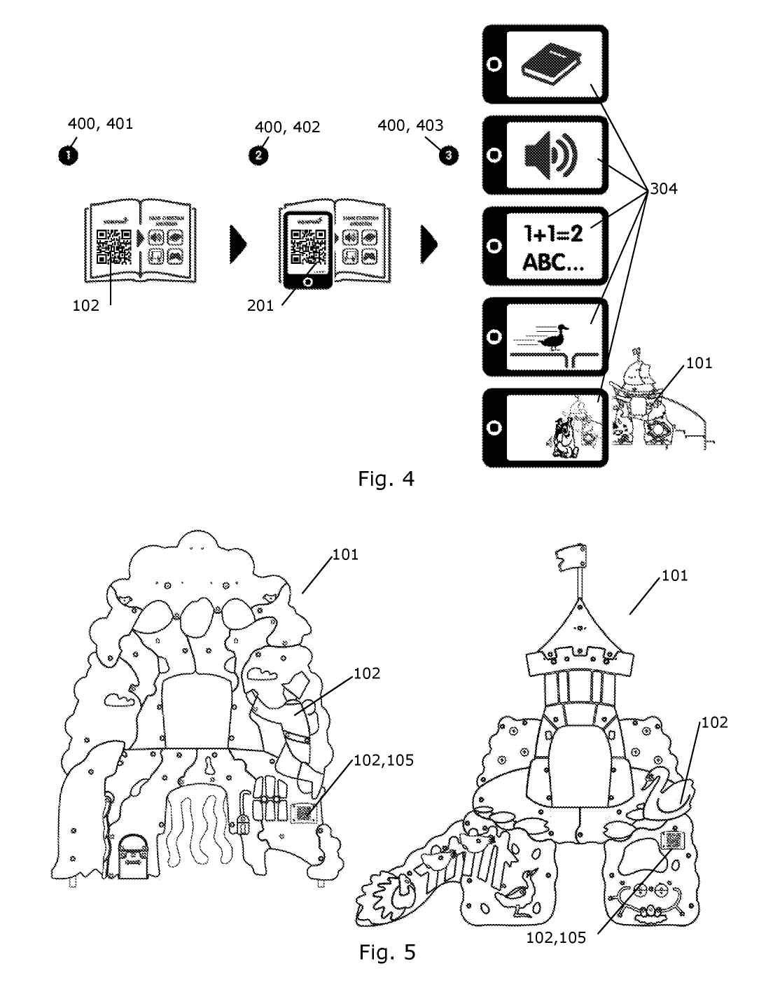

FIGS. 2 and 4 illustrate the interaction between different components of the playground system 100 according to the invention. The playground system 100 comprises a playground installation 101, a handheld computer device 201 which here is a smartphone, and a database 202. The computer device 201 comprises an identifier (not shown) so that it can read or scan an identifiable ID element 102 placed somewhere on the playground installation 101. The database 202 comprises of a number of digital applications relating to different educational and/or entertainment themes and is accessible by the computer device 201 either directly or indirectly via some network portal such as for example a phone app store. Upon reading of the identifiable ID element 102 of the playground installation, the computer device 201 identifies the educational and/or entertainment theme of the playground installation and accesses a digital application relating to the same educational and/or entertainment theme as that of the playground installation from the database 202. The database may comprise more applications directed to the same educational and/or entertainment theme for the user to choose from. Each application comprises one or more digital educational and/or entertainment content elements relating to the educational and/or entertainment theme of the application.

In this way the user at the playground is easily and fast yet effectively provided with access to one or more digital applications related to and relevant to the playground installation and thereby with an interconnection between the physical playground installation and the digital application both relating to the same educational and/or entertainment theme, and which can both be used and explored at the same time or in parallel. This increases the educational and/or entertainment and recreational value for the user of both the playground installation and the digital application.

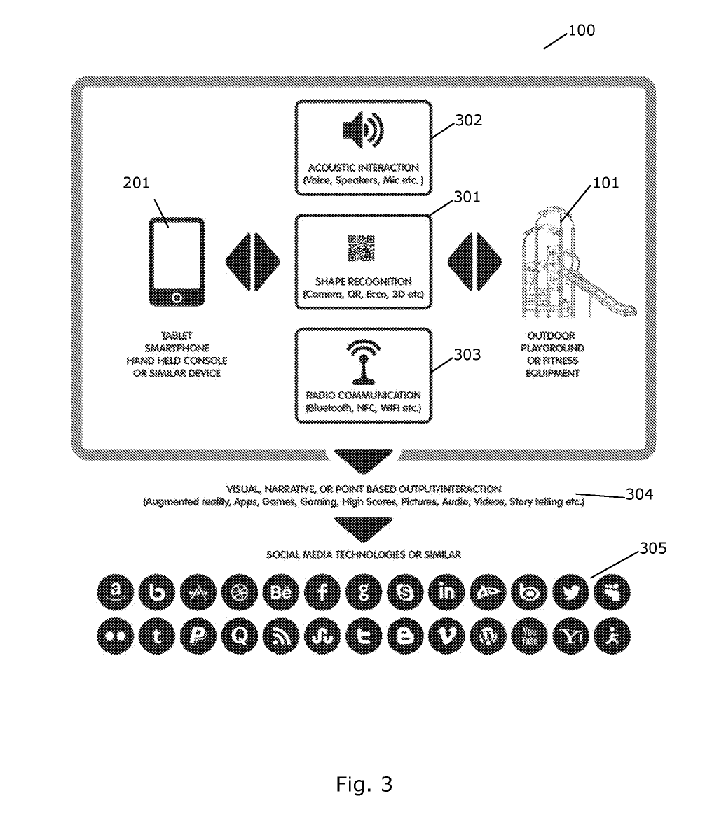

FIG. 3 illustrates the interaction between the playground installation 101 and the computer device 201 in the playground system 100. The computer device 201 can recognize, identify, and optionally track 301 different identifiable elements on the playground installation for example by scanning of a QR-code 105 or similar codes, by shape, pattern or text or LLA markers. The playground system can further include acoustic interaction 302 between the computer device and the playground installation by means of for example voice, speakers and microphones. Also, the playground system can include radio communication means 303 to make the computer device and the playground installation interact, for example Bluetooth, NFC, WIFI and the like.

These means may all or some of them be used in the different digital content elements 304 accessed via the digital application. The digital content elements can include both visual, narrative or point passed scoring interaction such as for example different games, pictures, audio clips or videos, storytelling, or augmented reality applications where the physical reality is blended with one or more virtual objects or elements. The playground system 100 may further link up to or otherwise support different social media technologies 305 such as twitter, Facebook, different net portals or communication media etc.

FIG. 4 illustrates the different levels 400 of interaction in the playground system 100 wherein in the first levels 401, 402 a handheld computer device 201 is used to identify the educational and/or entertainment theme of the playground installation 101 by means of the reading of an identifiable ID element 102 and accessing from a database 202 the relevant digital education application relating to the same theme. In a further level 402 different educational and/or entertainment content elements 304 are used in the interaction between the playground installation and the computer device. The educational and/or entertainment content elements here include an augmented reality platform displaying the physical playground installation with virtual objects and adding an interactive layer to the image frames. Other educational and/or entertainment content elements include displaying and or playing a story relating to the theme of the playground optionally with connected exercises. This can be combined with different reading or learning tools such as highlighting specific words which can be found on the playground installation. The digital content elements, 304 further include different games. The games can be played as isolated games or interconnected to the playground installation by different devices on the playground installation controlled from the computer device or which can be activated by a user on the playground installation affecting the game played on the computer device.

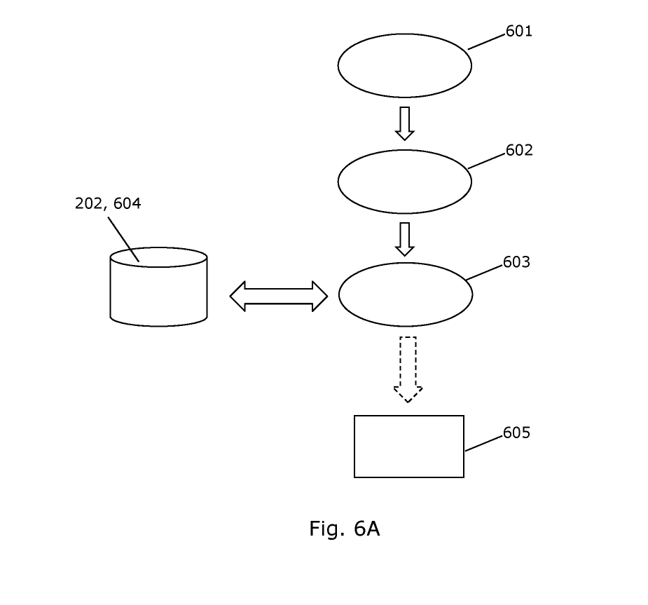

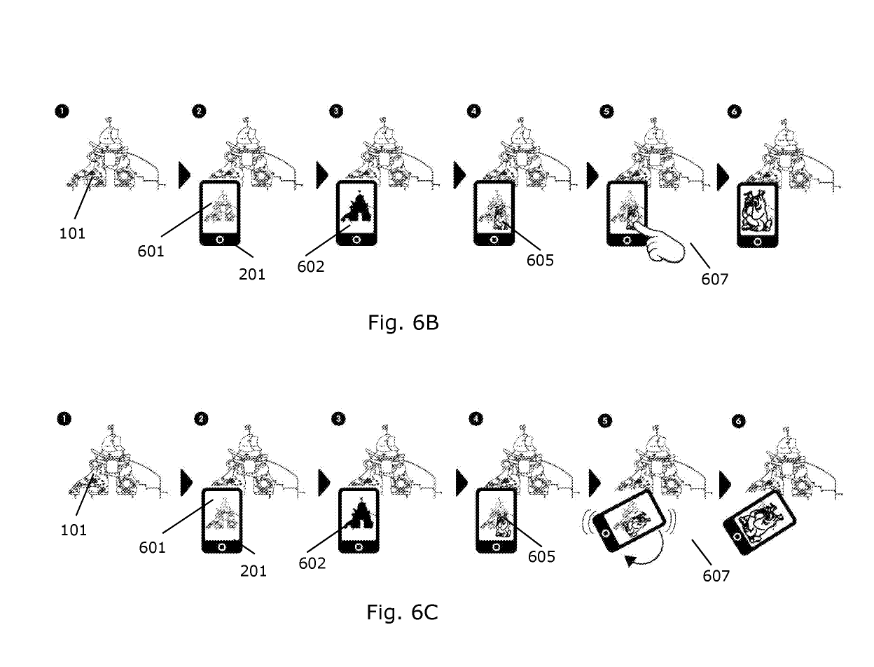

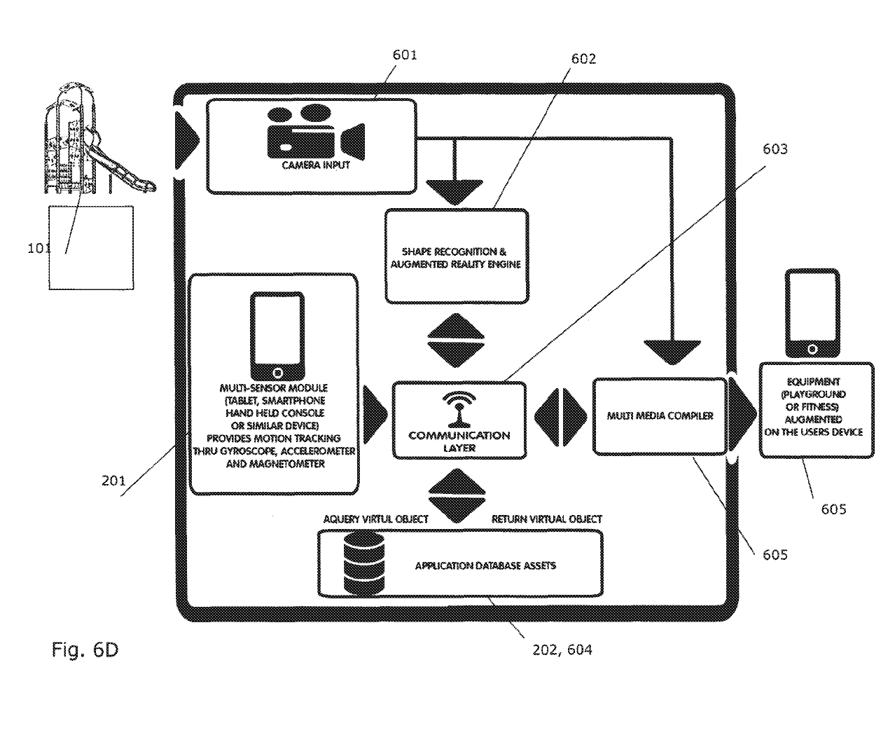

FIG. 6A is a flow chart illustrating the method steps in the application of object recognition used to create an augmented reality of the playground installation in the computer device. The steps in the creation of the augmented reality are also illustrated in FIGS. 6B, 6C, and 6D. By means of a built-in camera or similar video recording feature 601 in the computer device, an image frame 602 of a scene of the real world is acquired, and one or more identifiable objects can then be identified from the frame through shape recognition (using both object- and marker based tracking). The image of the object is collected into a communication compiler, and then 603 compared to the application database 202, 604 of identifiable elements and different virtual objects. The database may preferably for increased performance speed be stored locally or built in in the application itself. Additional input is supplied in the form of motion tracking from the users' device. Based on the comparison and additional input, the virtual object is returned with any relevant virtual objects (animations), which are then compiled 606 with the existing original camera input. This is rendered onto the screen of the computer device 605 as augmented reality.

FIGS. 6C and D also show different additional steps no 5-6 involved in the interaction with the applications augmented reality animation (the virtual layer). For example the user may trigger or execute 607 the animation by touch or motion of the device, thereby causing an interaction with and change to the animation, 608. This can be performed by the user no longer near or in view of the playground. In this way the user can continue the play and interaction with the playground at any time later.

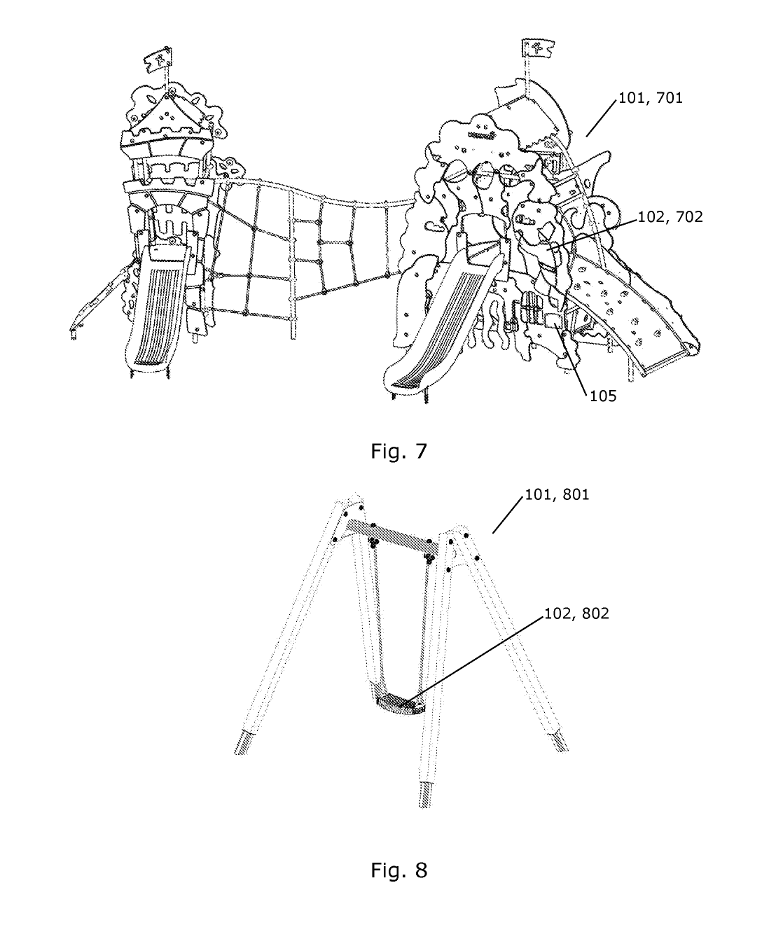

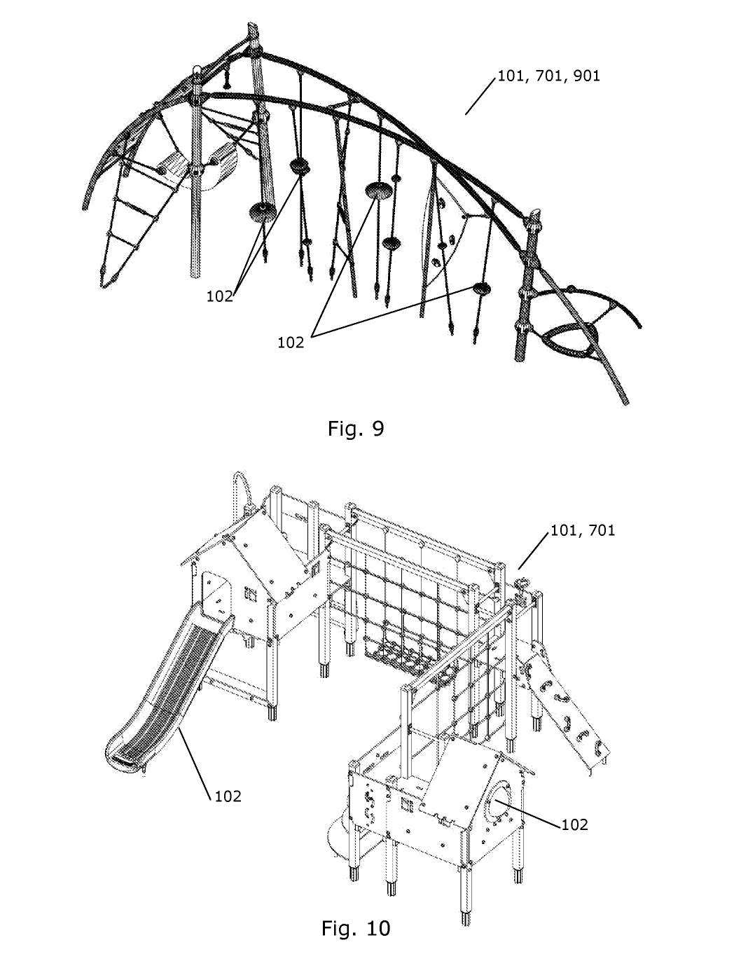

FIGS. 7-11 show different embodiments of playground installations 101 such as climbing structures 701, swings 801, fitness apparatus 901 or playing courts 1101 for different kinds of sport games. The playground installations comprise different types of identifiable ID elements 102, such as bar-codes or QR codes 105 (see FIG. 7), markers of different types or ID elements recognizable by means of object recognition (FIGS. 8-11).

In FIG. 7, different figures including the soldier figure 702 can be identified by shape recognition.

In FIG. 8, a marker is placed on the seat of the swing 802 such that the seat and its movement can be tracked by the computer device. This is used in an augmented reality application by the computer device to display the swing with a playing child but sitting on and riding a virtual object such as for example a dragon or a unicorn. Interactive properties are optionally assigned to the virtual object reacting upon touch by the player. The dragon can for example breathe fire or otherwise change any of the animation parameters when touched. Any interaction with the animation on the device displaying the animation will change the behavior and appearance of the particular animation, all in relation to the position of the marker on the swing seat.

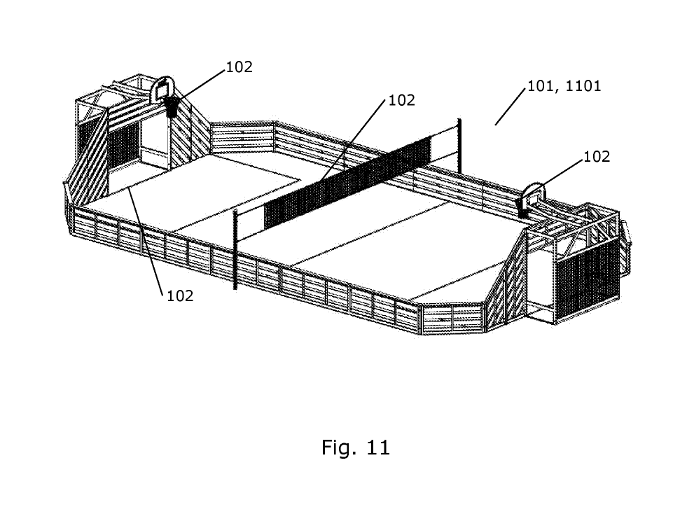

In the playing court 1101 shown in FIG. 11, the identifiable ID elements 102 are the goals or the net allowing the digital application for example to keep track of the scoring in the sports game.

### Further Embodiments of the Invention

### Embodiment 1

An interactive educational system comprising a playground installation and a handheld computer device, the playground installation comprising a three-dimensional physical object relating to an educational theme, and wherein the computer device comprises a digital educational content element relating to the same educational theme, and wherein the digital educational content element comprises a digital representation of the physical object of the playground installation thereby allowing a user to relate the physical object to its corresponding digital representation such as to increase the users understanding of the educational theme.

### Embodiment 2

Educational system according to embodiment 1, wherein the playground installation comprises a number of three-dimensional physical objects all relating to the same educational theme, and wherein the educational content element comprises a digital representation of a story comprising references to all the objects, and wherein the physical objects are placed on the playground installation such as to encourage the user to play the story.

### Embodiment 3

Educational system according to embodiment 2, wherein the physical objects are placed on the playground installation relative to each other according to their relationship in the story.

### Embodiment 4

Educational system according to embodiment 1, wherein the digital representation comprises a textual, sound or image representation of the physical object.

### Embodiment 5

Educational system according to embodiment 1, wherein the digital educational content element comprises displaying a story in text and/or images on a screen of the computer device and the digital representation comprises a textual or image representation of the physical object playing a part in the story.

### Embodiment 6

Educational system according to embodiment 1, wherein the physical object of the playground comprises an ID element identifiable by the computer device for identification of the educational theme of the playground installation, and the computer device comprises an identifier and is configured for accessing a database, the database comprising a number of digital applications, each application comprising digital educational content elements relating to an educational theme, and wherein the computer device is further configured for accessing the digital application relating to the educational theme of the playground installation upon identification of the ID element by means of the identifier.

### Embodiment 7

Educational system according to embodiment 6, wherein the ID element identifiable by the computer device comprises a marker belonging to the group of electronic passive or active tags such as RFID tags, bar codes, QR codes, ID markers, frame markers, picture markers, pattern marker, markerless 3D markers, GPS, and LLA markers.

### Embodiment 8

Educational system according to embodiment 6, wherein the ID element is identifiable by the computer device by means of shape, pattern, audio, or text recognition.

### Embodiment 9

Educational system according to embodiment 6, wherein the ID element comprises electronic ID data and is transferred to the computer device for identification by the computer device by means of data communication means such as radio communication, IR communication, a wire connection, or a docking station.

### Embodiment 10

Educational system according to embodiment 1, wherein the handheld computer device comprises a video and at least one motion sensor and a processor configured for determining the position and orientation of the computer device relative to the playground installation based on data from the motion sensor and the video.

### Embodiment 11

Educational system according to embodiment 6, wherein the handheld computer device further comprises a database of virtual objects relating to the educational theme of the playground installation and a touch sensitive screen for displaying an image frame including the playground installation as detected by the camera or the video, and further comprising a processor configured for rendering a virtual object relating to the educational theme of the playground installation on the screen within the image frame of the playground installation corresponding to the physical position of the identifiable ID element in the playground installation.

### Embodiment 12

Method of learning comprising

providing a playground installation comprising a three-dimensional physical object relating to an educational theme;

providing a handheld computer device comprising a digital educational content element relating to the same educational theme, and wherein the digital educational content element comprises a digital representation of the physical object of the playground installation;

allowing a user access to the physical object and at the same time to the digital educational content element, thereby promoting the user to relate the physical object to its corresponding digital representation such as to increase the users understanding of the educational theme.

### Embodiment 13

Method of learning according to embodiment 12 comprising:

providing on the playground installation an ID element identifiable by the computer device and for identification of the educational theme of the playground installation;

providing a database of a number of digital applications, each application comprising digital educational content elements relating to an educational theme;

using an identifier in the computer device to recognize the identifiable ID element and identify the educational theme of the playground installation;

using the computer device to access the database and access the digital application relating to the educational theme of the playground installation,

thereby providing the user of the playground installation access to the digital educational content elements relating to the same educational theme as the educational theme of the playground installation.

### Embodiment 14

Method of learning according to embodiment 12 wherein the digital educational content element comprises displaying a story in text and/or images on a screen of the computer device and the digital representation comprises a textual or image representation of the physical object playing a part in the story.

### Embodiment 15

Method of learning according to embodiment 12 wherein the computer comprises sound emitting means, and the digital educational content element comprises playing a story via the sound emitting means, and the digital representation comprises a sound representation of the physical object playing a part in the story.

### Embodiment 16

A method of learning according to embodiment 13, wherein the identifiable ID element of the playground installation is recognized by means shape, pattern, audio, or text recognition.

### Embodiment 17

A method of learning according to embodiment 13, further comprising tracking the identifiable ID element over time.

### Embodiment 18

A method of learning according to embodiments 12, further comprising displaying an image frame including the playground installation as detected by a camera or a video of the computer device, identifying an identifiable ID element of the playground installation within the image frame, and rendering a virtual object relating to the educational theme of the playground installation on the image frame such as to correspond to the physical position of the identifiable ID element in the playground installation.

### Embodiment 19

A method of learning according to embodiment 18, wherein the virtual object is retrieved from a database comprising a number of virtual objects each relating to one or more of the educational themes of different playground installations.

### Embodiment 20

A method of learning according to embodiment 18, further comprising detecting touch based input from the user and associating an action to the virtual object when touched by the user.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1-18. (canceled)

19. An interactive educational system comprising a playground installation and a handheld computer device, the playground installation comprising a three-dimensional physical object relating to an educational theme, and wherein the computer device comprises a digital educational content element relating to the same educational theme, and wherein the digital educational content element comprises a digital representation of the physical object of the playground installation thereby allowing a user to relate the physical object to its corresponding digital representation such as to increase the users understanding of the educational theme.

20. The educational system according to claim 19, wherein the playground installation comprises a number of three-dimensional physical objects all relating to the same educational theme, and wherein the educational content element comprises a digital representation of a story comprising references to all the objects, and wherein the physical objects are placed on the playground installation such as to encourage the user to play the story.

21. The educational system according to claim 20, wherein the physical objects are placed on the playground installation relative to each other according to their relationship in the story.

22. The educational system according to claim 19, wherein the digital representation comprises a textual, sound or image representation of the physical object.

23. The educational system according to claim 19, wherein the digital educational content element comprises displaying a story in text and/or images on a screen of the computer device and the digital representation comprises a textual or image representation of the physical object playing a part in the story.

24. The educational system according to claim 19, wherein the physical object of the playground comprises an ID element identifiable by the computer device for identification of the educational theme of the playground installation, and the computer device comprises an identifier and is configured for accessing a database, the database comprising a number of digital applications, each application comprising digital educational content elements relating to an educational theme, and wherein the computer device is further configured for accessing the digital application relating to the educational theme of the playground installation upon identification of the ID element by means of the identifier.

25. The educational system according to claim 24, wherein the ID element identifiable by the computer device comprises a marker belonging to the group of electronic passive or active tags such as RFID tags, bar codes, QR codes, ID markers, frame markers, picture markers, pattern marker, markerless 3D markers, GPS, and LLA markers.

26. The educational system according to claim 24, wherein the ID element is identifiable by the computer device by means of shape, pattern, audio, or text recognition.

27. The educational system according to claim 24, wherein the ID element comprises electronic ID data and is transferred to the computer device for identification by the computer device by means of data communication means such as radio communication, IR communication, a wire connection, or a docking station.

28. The educational system according to claim 19, wherein the handheld computer device comprises a video and at least one motion sensor and a processor configured for determining the position and orientation of the computer device relative to the playground installation based on data from the motion sensor and the video.

29. The educational system according to claim 24, wherein the handheld computer device further comprises a database of virtual objects relating to the educational theme of the playground installation and a touch sensitive screen for displaying an image frame including the playground installation as detected by the camera or the video, and further comprising a processor configured for rendering a virtual object relating to the educational theme of the playground installation on the screen within the image frame of the playground installation corresponding to the physical position of the identifiable ID element in the playground installation.

30. A method of learning comprising
providing a playground installation comprising a three-dimensional physical object relating to an educational theme;
providing a handheld computer device comprising a digital educational content element relating to the same educational theme, and wherein the digital educational content element comprises a digital representation of the physical object of the playground installation;
allowing a user access to the physical object and at the same time to the digital educational content element, thereby promoting the user to relate the physical object to its corresponding digital representation such as to increase the users understanding of the educational theme.

31. The method of learning according to claim 30, comprising:
providing on the playground installation an ID element identifiable by the computer device and for identification of the educational theme of the playground installation;
providing a database of a number of digital applications, each application comprising digital educational content elements relating to an educational theme;
using an identifier in the computer device to recognize the identifiable ID element and identify the educational theme of the playground installation;
using the computer device to access the database and access the digital application relating to the educational theme of the playground installation,
thereby providing the user of the playground installation access to the digital educational content elements relating to the same educational theme as the educational theme of the playground installation.

32. The method of learning according to claim 30, wherein the digital educational content element comprises displaying a story in text and/or images on a screen of the computer device and the digital representation comprises a textual or image representation of the physical object playing a part in the story.

33. The method of learning according to claim 30, wherein the computer comprises sound emitting means, and the digital educational content element comprises playing a story via the sound emitting means, and the digital representation comprises a sound representation of the physical object playing a part in the story.

34. The method of learning according to claim 31, wherein the identifiable ID element of the playground installation is recognized by means shape, pattern, audio, or text recognition.

35. The method of learning according to claim 31, further comprising tracking the identifiable ID element over time.

36. The method of learning according to claim 30, further comprising displaying an image frame including the playground installation as detected by a camera or a video of the computer device, identifying an identifiable ID element of the playground installation within the image frame, and rendering a virtual object relating to the educational theme of the playground installation on the image frame such as to correspond to the physical position of the identifiable ID element in the playground installation.

37. The method of learning according to claim 36, wherein the virtual object is retrieved from a database comprising a number of virtual objects each relating to one or more of the educational themes of different playground installations.

38. The method of learning according to claims 36, further comprising detecting touch based input from the user and associating an action to the virtual object when touched by the user.
